(19) United States
(12) Patent Application Publication
(10) Pub. No.: US 2017/0350302 A1
(43) Pub. Date: Dec. 7, 2017

(54) WATER JACKET SPACER, INTERNAL COMBUSTION ENGINE, AND AUTOMOBILE

(71) Applicants: NICHIAS CORPORATION, Tokyo (JP); TOTYA JIDOSHA KABUSHIKI KAISHA, Aichi (JP)

(72) Inventors: Yukari Araki, Toyota-shi (JP); Kentaro Mushiga, Toyota-shi (JP); Yoshihiro Kawasaki, Yokohama-shi (JP); Yoshifumi Fujita, Hamamatsu-shi (JP)

(73) Assignee: NICHIAS CORPORATION, Tokyo (JP)

(21) Appl. No.: 15/538,300

(22) PCT Filed: Dec. 21, 2015
(86) PCT No.: PCT/JP2015/085708

§ 371 Date: Jun. 21, 2017

(30) Foreign Application Priority Data
Dec. 22, 2014 (JP) 2014-258313

(51) Int. Cl. F01P 3/02; F02F 1/14

(52) U.S. Cl. CPC F01P 3/02; F02F 1/14

(57) ABSTRACT

A water jacket spacer is provided that ensures that a cylinder bore wall has a uniform temperature. When a contact member that comes in contact with the all surface of a groove-like coolant passage is provided to either or both of the inner wall side and the outer wall side of the water jacket spacer along the longitudinal direction of the water jacket spacer to divide the groove-like coolant passage into an upper part and a lower part, it is possible to separately control the flow rate of the coolant that flows through the upper passage of the groove-like coolant passage, and the flow rate of the coolant that flows through the lower passage of the groove-like coolant passage, and separately adjust the degree of cooling with respect to the upper part and the lower part of the cylinder bore wall.

### TECHNICAL FIELD

The present invention relates to a water jacket spacer that is inserted into a groove-like coolant passage provided to a cylinder block that is provided to an internal to combustion engine, and used to control the flow of a coolant that flows through the groove-like coolant passage, an internal combustion engine that includes the water jacket spacer, and an automobile that includes the internal combustion engine.

### BACKGROUND ART

An internal combustion engine is designed so that fuel explodes within the cylinder bore when the piston is positioned at top dead center, and the piston is moved downward due to the explosion. Therefore, the upper part of the cylinder bore wall increases in temperature as compared with the middle-lower part of the cylinder bore wall. Accordingly, a difference in the amount of thermal deformation occurs between the upper part and the middle-lower part of the cylinder bore wall (i.e., the upper part of the cylinder bore wall expands to a large extent as compared with the middle-lower part of the cylinder bore wall).

As a result, the frictional resistance of the piston against the cylinder bore wall increases, and the fuel consumption increases. Therefore, a reduction in difference in the amount of thermal deformation between the upper part and the middle-lower part of the cylinder bore wall has been desired.

Attempts have been made to control the cooling efficiency in the upper part and the lower part of the cylinder bore wall due to the coolant by disposing a water jacket spacer in a groove-like coolant passage to adjust the flow of the coolant in the groove-like coolant passage such that the cylinder bore wall has a uniform temperature. For example, Patent Literature 1 discloses an internal combustion engine heating medium passage partition member that is disposed in a groove-like heating medium passage formed in a cylinder block of an internal combustion engine to divide the groove-like heating medium passage into a plurality of passages, the heating medium passage partition member including a passage division member that is formed at a height above the bottom of the groove-like heating medium passage, and serves as a wall that divides the groove-like heating medium passage into a bore-side passage and a non-bore-side passage, and a flexible lip member that is formed from the passage division member in the opening direction of the move-like heating medium passage, the edge area of the flexible lip member being formed of a flexible material to extend beyond the inner surface of one of the groove-like heating medium passages, and coming in contact with the inner surface at a middle position of the groove-like heating medium passage in the depth direction dire to the flexure restoring force after insertion into the move-like heating medium passage to separate the bore-side passage and the non-bore-side passage.

### CITATION LIST

### Patent Literature

Patent Literature 1: JP-A-2008-31939 (claims)

### SUMMARY OF INVENTION

### Technical Problem

According to the internal combustion engine heating medium passage partition member disclosed in Patent Literature 1, since the temperature of the cylinder bore wall can be made uniform to a certain extent, the difference in the amount of thermal deformation between the upper area and the lower area of the cylinder bore wall can be reduced. However, a further reduction in the difference in the amount of thermal deformation between the upper area and the lower area of the cylinder bore wall has been desired.

An object of the invention is to provide a water jacket spacer that ensures that the cylinder bore wall has a uniform temperature, an internal combustion engine that includes the water jacket spacer, and an automobile that includes the internal combustion engine.

### Solution to Problem

The inventors conducted extensive studies in order to solve the above problem, and found that, when a contact member that conies in contact with the wall surface of the groove-like coolant passage is provided to either or both of the inner wall side and the outer wall side of the water jacket spacer along the longitudinal direction of the water jacket spacer to divide the groove-like coolant passage into an upper part and a lower part, it is possible to separately control the flow rate of the coolant that flows through the upper passage of the groove-like coolant passage, and the flow rate of the coolant that flows through the lower passage of the groove-like coolant passage, and separately adjust the degree of cooling with respect to the upper part and the lower part of the cylinder bore wall. This finding has led to the completion of the invention.

(1) According to one aspect of the invention, a water jacket spacer is inserted into a groove-like coolant passage provided to a cylinder block that is provided to an internal combustion engine, and includes a main body that has a shape that conforms to the groove-like coolant passage, and either or both of an inner wall-side contact member and an outer wall-side contact member, the inner wall-side contact member being disposed on the inner wall side of the main body along the longitudinal direction of the inner wall of the main body, and coming into contact with the cylinder bore-side wall surface of the groove-like coolant passage to divide the groove-like coolant passage situated on the inner side with respect to the water jacket spacer into an upper part and a to lower part, and the outer wall-side contact member being disposed on the outer wall side of the main body along the longitudinal direction of the outer wall of the main body, and coming into contact with the outer wall surface of the groove-like coolant passage to divide the groove-like coolant passage situated on the outer side with respect to the water jacket spacer into an upper part and a lower part.
(2) According, to another aspect of the invention, n internal combustion engine includes the water jacket spacer according to (1) that is disposed in a groove-like coolant passage provided to a cylinder block.
(3) According to a further aspect of the invention, an automobile includes the internal combustion engine according to (2).

### Advantageous Effects of Invention

The aspects of the invention thus provide a water jacket spacer that ensures that the cylinder bore wall has a uniform temperature, an internal combustion engine that includes the water jacket spacer, and an automobile that includes the internal combustion engine.

### BRIEF DESCRIPTION OF DRAWINGS

FIG. is a schematic plan view illustrating an example of a cylinder block in which a water jacket spacer according to one embodiment of the invention is disposed.

FIG. 2 is an end view taken along the line x-x illustrated in FIG. 1.

FIG. 3 is a perspective view illustrating the cylinder block illustrated in FIG 1.

FIG. 4 is a schematic perspective view illustrating an example of a water jacket spacer according to one embodiment of the invention.

FIG. 5 is a top view illustrating the water jacket spacer illustrated in FIG. 4.

FIG. 6 is an end view taken along the line y-y illustrated in FIG. 5.

FIG. 7 is a schematic view illustrating a state in which the water jacket spacer illustrated in FIG. 4 is inserted into the cylinder block illustrated in FIG. 2.

FIG. 8 is a schematic view illustrating a state in which the water jacket spacer illustrated in FIG. 4 is disposed in a groove-like coolant passage provided to the cylinder block illustrated in FIG. 2.

FIG. 9 is a view illustrating a groove-like coolant passage from a cylinder bore-side wall surface in a state in which a water jacket spacer is disposed in the groove-like coolant passage.

FIG. 10 is an end view illustrating a state in Which a water jacket spacer is disposed in a groove-like coolant passage.

FIG. 11 is a plan view illustrating an example of a main body.

FIGS. 12A and 12B are a schematic view illustrating an example of an outer wall-side contact member.

FIGS. 13A and 13B are a schematic view illustrating an example of an inner wall-side contact member.

FIGS. 14A and 14B are a schematic view illustrating an example of an inner wall-side contact member and an outer wall-side contact member.

### DESCRIPTION OF EMBODIMENTS

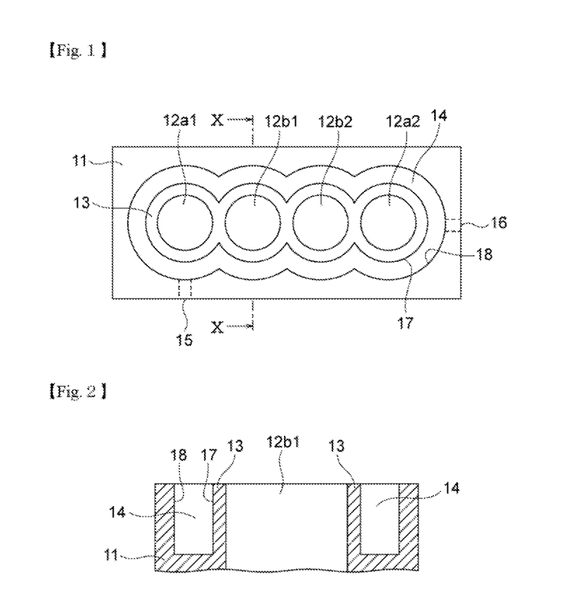

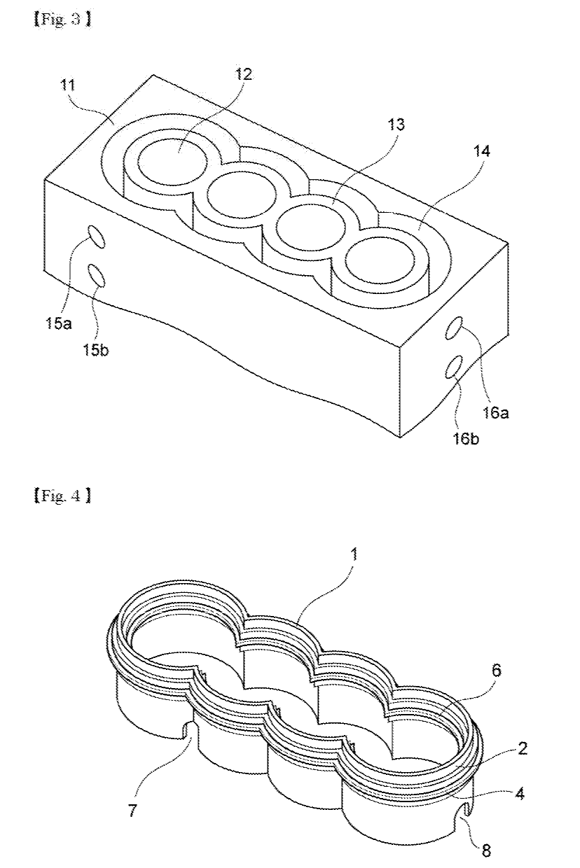

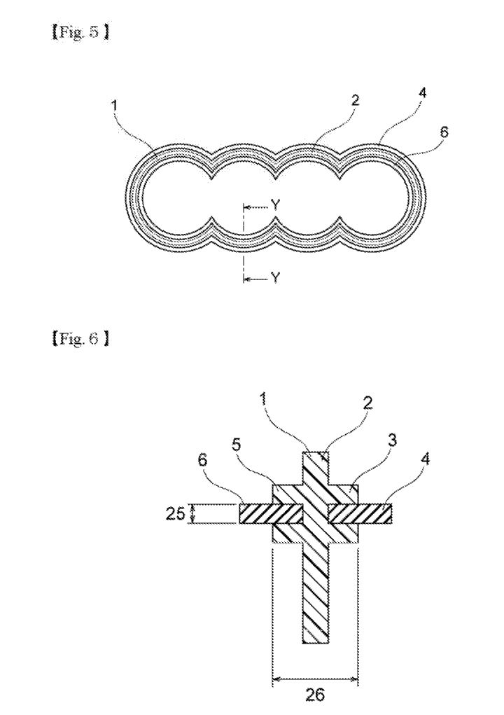

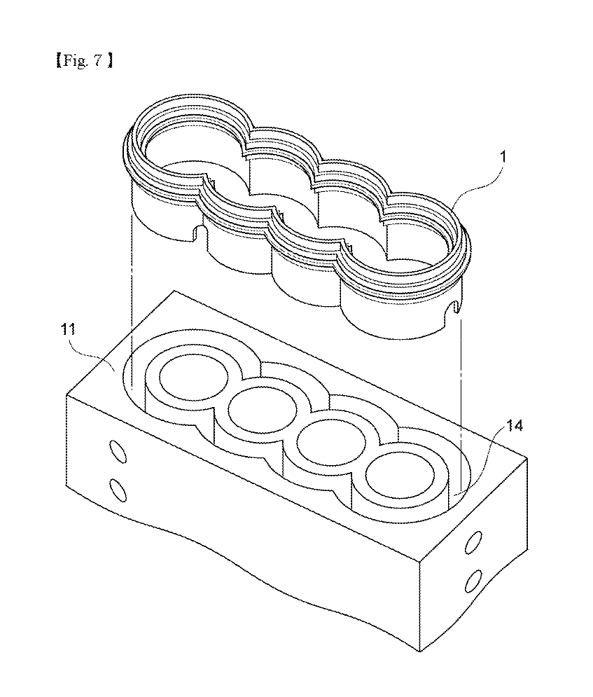

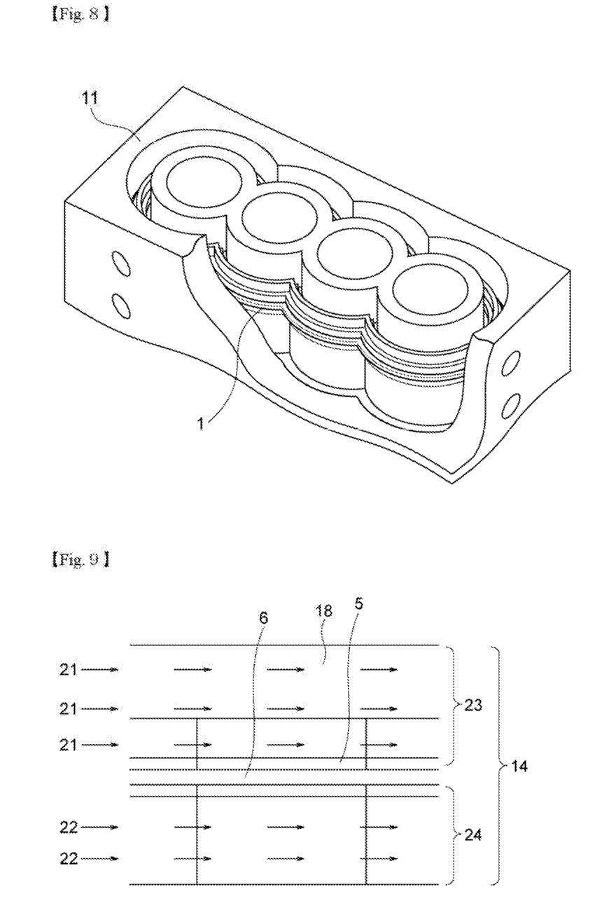

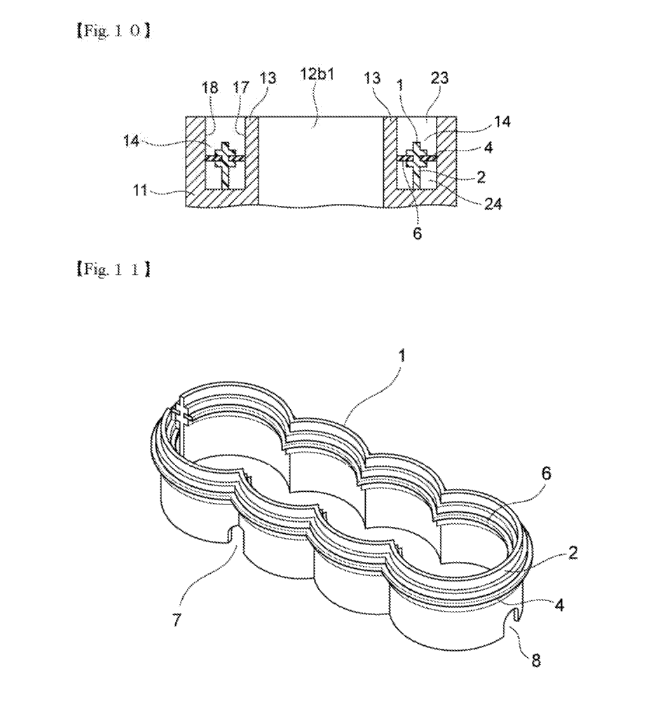

A water jacket spacer according to one embodiment of the invention, and an internal combustion engine that includes the water jacket spacer according to one embodiment of the invention, are described below with reference to FIGS. 1 to 10. FIGS. 1 to 3 illustrate an example of a cylinder block in which the water jacket spacer according to one embodiment of the invention is disposed. FIG. 1 is a schematic plan view illustrating the cylinder block in which the water jacket spacer according to one embodiment of the invention is disposed FIG. 2 is an end view taken along the line x-x illustrated in FIG. 1, and FIG. 3 is a perspective view illustrating the cylinder block illustrated in FIG. 1. FIGS. 4 to 6 illustrate an example of the water jacket spacer according to one embodiment of the invention. FIG. 4 is a schematic perspective view illustrating an example of the water jacket spacer according to one embodiment of the invention, FIG. 5 is a top view illustrating the water jacket spacer illustrated in FIG. 4, and FIG. 6 is an end view taken along the line y-y illustrated in FIG. 4. FIG. 7 is a schematic view illustrating a state in which the water jacket spacer illustrated in FIG. 4 is inserted into the cylinder block illustrated in FIG. 2, FIG. 8 is a schematic view illustrating a state in which the water jacket spacer illustrated in FIG. 4 is disposed in a groove-like coolant passage provided to the cylinder block illustrated in FIG. 2, FIG. 9 is a view illustrating the groove-like coolant passage from a cylinder bore-side wall surface in a state in which the water jacket spacer is disposed in the groove-like coolant passage, and FIG. 10 is an end view illustrating a state in which the water jacket spacer is disposed in the groove-like coolant passage.

As illustrated in FIGS. 1 to 3, an open-deck cylinder block 11 for an automotive internal combustion engine (in which the water jacket spacer is disposed) includes a plurality of bores 12 and a groove-like coolant passage 14, a piston moving upward and downward in each bore 12, and a coolant flowing through the wove-like coolant passage 14. The boundary between the bores 12 and the groove-like coolant passage 14 is defined by a cylinder bore wall 13. The cylinder block 11 also includes coolant inlets 15a and 15b for supplying the coolant to the groove-like coolant passage 14, and coolant outlets 16a and 16b for discharging the coolant from the groove-like coolant passage 11. The coolant inlet 15a is an inlet for supplying the coolant to the upper passage of the groove-like coolant passage 14, the coolant inlet 15b is an inlet for supplying the coolant to the lower passage of the groove-like coolant passage 14, the coolant outlet 16a is an outlet for discharging the coolant from the upper passage of the groove-like coolant passage 14, and the coolant outlet lob is an outlet for discharging the coolant from the lower passage of the groove-like coolant passage 14.

The cylinder block 11 includes two or more bores 12 that are formed (arranged) in series. Specifically, the bores 12 include end bores 12a1 and 12a2 that are formed to be adjacent to one bore, and intermediate bores 12b1 and 12b2 that are formed between two bores. Note that only the end bores are provided when the number of bores formed in the cylinder block is 2. The end bores 12a1 and 12a2 among the bores 12 that are arranged in series are bores situated on either end, and the intermediate bores 12b1 and 12b2 among the bores 12 that are arranged in series are bores situated between the end bore 12a1 situated on one end and the end bore 12a2 situated on the other end.

The wall surface of the groove-like coolant passage 14 that is situated on the side of the cylinder bores is referred to as “cylinder bore-side wall surface 17”, and the wall surface of the groove-like coolant passage 14 that is situated opposite to the cylinder bore-side wall surface 17 is referred to as “outer wall surface 18”.

A water jacket spacer 1 illustrated in FIGS. 4 to 6 includes a main body 2, an inner wall-side contact member 6, and an outer wall-side contact member 4.

The main body 2 is a member that is disposed in the middle-lower part of the groove-like coolant passage 14 so that the center and its vicinity of the middle-lower part of the groove-like coolant passage 14 in the width direction is filled with the main body 2. The main body 2 has a shape that conforms to the shape of the groove-like coolant passage 14 when viewed from above. In other words, the main body 2 has a to shape that surrounds the cylinder bore-side wall surface 17 of the groove-like coolant passage 14 when viewed from above.

The inner wall-side contact member 6 is disposed along the longitudinal direction transverse direction) of the inner wall of the main body 2 so as to surround the cylinder bore-side wall surface 17 of the groove-like coolant passage 14. The inner wall-side contact member 6 is disposed on the inner wall side of the main body 2 in a state in which the inner wall-side contact member 6 is fitted into an inner wall-side contact member-receiving section 5 formed on the inner wall side of the main body 2.

The outer wall-side contact member 4 is disposed along the longitudinal direction (transverse direction) of the outer wall of the main body 2 so as to surround the main body 2. The outer wall-side contact member 4 is disposed on the outer wall side of the main body 2 in a state in which the outer wall-side contact member 4 is fitted into an outer wall-side contact member-receiving section 35 formed on the outer wall side of the main body 2.

An inflow hole 7 that allows the coolant to enter the coolant passage formed between the main body 2 and the cylinder bore-side wall surface of the groove-like coolant passage is formed at a position lower than the position of the inner wall-side contact member 4 and the outer wall-side contact member 6 is the height direction, and an outflow hole 8 that allows the coolant to be discharged from the coolant passage formed between the main body 2 and the cylinder bore-side wall surface of the groove-like coolant passage into the coolant passage formed between the main body 2 and the outer wall surface of the groove-like coolant passage is formed at a position lower than the position of the inner wall-side contact member 4 and the outer wall-side contact member 6 in the height direction.

As illustrated in FIG. 7, the water jacket spacer 1 is inserted into the groove-like coolant passage 14 provided to the cylinder block 11, and disposed in the groove-like coolant passage 14 (see FIGS. 8 to 10). Note that FIG. 9 illustrates only the main body, the inner wall-side contact member, and the outer wall surface of the groove-like coolant passage.

When the water jacket spacer 1 is disposed in the groove-like coolant passage 14, the inner wall-side contact member 6 comes in contact with the cylinder bore-side wall surface 17 of the groove-like coolant passage 14, and the outer wall-side contact member 4 comes in contact with the outer wall surface 18 of the groove-like coolant passage 14.

When the inner wall-side contact member 6 has come in contact with the cylinder bore-side wall surface 17 of the groove-like coolant passage 14, and the outer wall-side contact member 4 has come in contact with the outer wall surface 18 of the groove-like coolant passage 14, the groove-life coolant passage 14 is divided into an upper passage 23 and a lower passage 24. Therefore, when a pump that supplies a coolant 21 to the upper passage 23 of the groove-like coolant passage, and a pump that supplies a coolant 22 to the lower passage 24 of the groove-like coolant passage, are separately provided, it is possible to cause the flow rate of the coolant to differ between the upper passage 23 and the lower passage 24 of the groove-like coolant passage, and separately adjust the flow rate of the coolant that flows through the upper passage 23 of the groove-like coolant passage, and the flow rate of the coolant that flows through the lower passage 24 of the groove-like coolant passage.

The water jacket spacer according to one aspect of the invention is inserted into to a groove-like coolant passage provided to a cylinder block that is provided to an internal combustion engine, and includes a main body that has a shape that conforms to the groove-like coolant passage, and either or both of an inner wall-side contact member and an outer wall-side contact member, the inner wall-side contact member being disposed on the inner wall side of the main body along the longitudinal direction of the inner wall of the main body, and coming into contact with the cylinder bore-side wall surface of the groove-like coolant passage to divide the groove-like coolant passage situated on the inner side with respect to the water jacket spacer into an upper part and a lower part, and the outer wall-side contact member being disposed on the outer wall side of the main body along the longitudinal direction of the outer wall of the main body, and coming into contact with the outer wall surface of the groove-like coolant passage to divide the groove-like coolant passage situated on the outer side with respect to the water jacket spacer into an upper part and a lower part.

The water jacket spacer according to one aspect of the invention may be implemented as described below.

A water jacket spacer according to a first embodiment of the invention is inserted into a groove-like coolant passage provided to a cylinder block that is provided to an internal combustion engine, and includes a main body that has a shape that conforms to the entirety of the groove-like coolant passage, an inner wall-side contact member, and an outer wall-side contact member, the inner wall-side contact member being disposed on the inner wall side of the main body along the longitudinal direction of the inner wall of the main body over the entirety of the inner wall of the main body, and coming into contact with the cylinder bore-side wall surface of the groove-like coolant passage to divide the groove-like coolant passage situated on the inner side with respect to the water jacket spacer into an upper part and a lower part, and the outer wall-side contact member being disposed on the outer wall side of the main body along the longitudinal direction of the outer wall of the main body over the entirety of the outer wall of the main body, and coming into contact with the outer wall surface of the groove-like coolant passage to divide the groove-like coolant passage situated on the outer side with respect to the water jacket spacer into an upper part and a lower part.

A water jacket spacer according to a second embodiment of the invention is inserted into a groove-like coolant passage provided to a cylinder block that is provided to an internal combustion engine, and includes a main body that has a shape that conforms to the entirety of the groove-like coolant passage, and an inner wall-side contact member, the inner wall-side contact member being disposed on the inner wall side of the main body along the longitudinal direction of the inner wall of the main body over the entirely of the inner wall of the main body, and coming into contact with the cylinder bore-side wall surface of the groove-like coolant passage to divide the groove-like coolant passage situated on the inner side with respect to the water jacket spacer into an upper part and a lower part.

A water jacket spacer according to a third embodiment of the invention is inserted into a groove-like coolant passage provided to a cylinder block that is provided to an internal combustion engine, and includes a main body that has a shape that conforms to the entirety of the groove-like coolant passage, and an outer wall-side contact member the outer wall-side contact member being disposed on the outer wall side of the main body along the longitudinal direction of the outer wall of the main body over the entirely of the outer wall of the main body, and coming into contact with the outer wall surface of the groove-like coolant passage to divide the groove-like coolant passage situated on the outer side with respect to the water jacket spacer into an upper part and a lower part.

A water jacket spacer according to a fourth embodiment of the invention is inserted into a groove-like coolant passage provided to a cylinder block that is provided to an internal combustion engine, and includes a main body that has a shape that conforms to the entirety of the groove-like coolant passage, an inner wall-side contact member, and an outer wall-side contact member, the inner wall-side contact member being partially disposed on the inner wall side of the main body along the longitudinal. direction of the inner wall of the main body, and coming into contact with the cylinder bore-side wall surface of the groove-like coolant passage to divide the groove-like coolant passage situated on the inner side with respect to the water jacket spacer into an upper part and a lower part, and the outer wall-side contact member being partially disposed on the outer wall side of the main body along the longitudinal direction of the outer wall of the main body, and coining into contact with the outer wall surface of the groove-like coolant passage to divide the groove-like coolant passage situated on the outer side with respect to the water jacket spacer into an upper part and a lower part.

A water jacket spacer according to a fifth embodiment of the invention is inserted into a groove-like coolant passage provided to a cylinder block that is provided to an internal combustion engine, and includes a main body that has a shape that conforms to part of the groove-like coolant passage, an inner wall-side contact member, and an outer wall-side contact member, the inner wall-side contact member being disposed on the inner wall side of the math body along the longitudinal direction of the inner wall of the main body over the entirety of the inner wall of the main body, and coming into contact with the cylinder bore-side wall surface of the groove-like coolant passage to divide the groove-like coolant passage situated on the inner side with respect to the water jacket spacer into an upper part and a lower part, and the outer wall-side contact member being disposed on the outer wall side of the main body along the longitudinal direction of the outer wall of the main body over the entirety of the outer wall of the main body, and coming into contact with the outer wall surface of the groove-like coolant passage to divide the groove-like coolant passage situated on the outer side with respect to the water jacket spacer into an upper part and a lower part.

A water jacket spacer according to a sixth embodiment of the invention is inserted into a groove-like coolant passage provided to a cylinder block that is provided to an internal combustion engine, and includes a main body that has a shape that conforms to part of the groove-like coolant passage, and an inner wall-side contact member, the inner wall-side contact member being disposed on the inner wall side of the main body along the longitudinal direction of the inner wall of the main body over the entirety of the inner wall of the main body, and coming into contact with the cylinder bore-side wall surface of the groove-like coolant passage to divide the groove-like coolant passage situated on the inner side with respect to the water jacket spacer into an upper part and a lower part.

A water jacket spacer according to a seventh embodiment of the invention is inserted into a groove-like coolant passage provided to a cylinder block that is provided to an internal combustion engine, and includes a main body that has a shape that conforms to part of the groove-like coolant passage, and an outer wall-side contact member, the outer wall-side contact member being disposed on the outer wall side of the main body along the longitudinal direction of the outer wall of the main body over the entirety of the outer wall of the main body, and coming into contact with the outer wall surface of the groove-like coolant passage to divide the groove-like coolant passage situated on the outer side with respect to the water jacket spacer into an upper part and a lower part.

A water jacket spacer according to an eighth embodiment of the invention is inserted into a groove-like coolant passage provided to a cylinder block that is provided to an internal combustion engine, and includes a main body that has a shape that conforms to part of the groove-like coolant passage, an inner wall-side contact member, and an outer wall-side contact member, the inner wall-side contact member being partially disposed on the inner wall side of the main body along the longitudinal direction of the inner wall of the main body, and coming into contact with the cylinder bore-side wall surface of the groove-like coolant passage to divide the groove-like coolant passage situated on the inner side with respect to the water jacket spacer into an upper part and a lower part, and the outer wall-side contact member being partially disposed on the outer wall side of the main body along the longitudinal direction of the outer wall of the main body, and coming into contact with the outer wall surface of the groove-like coolant passage to divide the groove-like coolant passage situated on the outer side with respect to the water jacket spacer into an upper part and a lower part.

The main body is a member that is disposed in the middle-lower part or the lower part of the groove-like coolant passage so that the center and its vicinity of the middle-lower part or the lower part of the groove-like coolant passage in the width direction is filled with the main body. The main body also serves as a member that supports the inner wall-side contact member or the outer wall-side contact member within the groove-like coolant passage so that the inner wall-side contact member or the outer wall-side contact member in the groove-like, coolant passage is fixed at a specific position. Therefore, the main body has a shape that conforms to the shape of the groove-like coolant passage when viewed from above. More specifically, the main body has a shape that conforms to the shape of part or the entirely of the groove-like coolant passage.

In the example illustrated in FIG. 4, the main body has a shape that surrounds the entirety of the cylinder bore-side wall surface of the groove-like coolant passage. Note that the shape of the main body is not particularly limited as long as the main body can support the inner wall-side contact member or the outer wall-side contact member so that the inner wall-side contact member or the outer wall-side contact member in the groove-like coolant passage is fixed at a specific position, and it is possible to separately adjust the flow rate of the coolant that flows through the upper passage of the groove-like coolant passage, and the flow rate of the coolant that flows through the lower passage of the groove-like coolant passage. For example, the main body may have a shape that is partially removed in the longitudinal direction (i.e. may have a shape that conforms to part of then groove-like coolant passage) (see FIG. 11) as long as the main body can support the inner wall-side contact member and the outer wall-side contact member so that it is possible to substantially separately adjust the flow rate of the coolant that flows through the upper passage of the groove-like coolant passage, and the flow rate of the coolant that flows through the lower passage of the groove-like coolant passage.

In the example illustrated in FIG. 4, an inflow hole that allows the coolant to enter the coolant passage formed between the main body and the cylinder bore-side wall surface of the groove-like coolant passage, and an outflow hole that allows the coolant to be discharged from the coolant passage formed between the main body and the cylinder bore-side wall surface of the wove-like coolant passage into the coolant passage formed between the main body and the outer wall surface of the groove-like coolant passage, are formed. Note that an arbitrary configuration may be employed as long as the coolant can enter the coolant passage formed between the main body and the cylinder bore-side wall surface of the groove-like coolant passage, and can be discharged from the coolant passage formed between the main body and the cylinder bore-side wall surface of the groove-like coolant passage. For example, part of the water jacket spacer that is situated at a position lower than the position of the inner wall-side contact member or the outer wall-side contact member in the height direction, may have been removed, or only a small part may be provided at a position lower than the position of the inner wall-side contact member or the outer wall-side contact member in the height direction.

The height of the main body is not particularly limited as long as the main body can support the inner wall-side contact member or the outer wall-side contact member so that the inner wall-side contact member or the outer wall-side contact member in the groove-like coolant passage is fixed at a specific position. In the example illustrated in FIG. 4, the main body has a uniform height in the longitudinal direction. Note that the main body may have a non-uniform height in the longitudinal direction.

A material for producing the main body is not particularly limited as long as the material exhibits excellent long-life coolant resistance (hereinafter referred to as “LLC resistance”), and exhibits a heat resistance sufficient to endure the temperature within the groove-like coolant passage. Examples of the material for producing the main body include a thermoplastic resin (e.g., polyethylene, polytetrafluoroethylene, polypropylene, polystyrene, acrylonitrile, butadiene, styrene resin, polyvinyl chloride, acrylonitrile, styrene resin, methacrylic resin, vinyl chloride, polyamide, polyacetal, polycarbonate, modified polyphenylene ether, polybutylene terephthalate, GF-reinforced polyethylene terephthalate, ultrahigh-molecular-weight polyethylene, polyphenylene sulfide, polyimide, polyetherimide, polyarylate, polysulfone, polyethersulfone, polyether ether ketone, and liquid crystal polymer), a thermosetting resin such as a polyester (e.g., polyethylene terephthalate, polybutylene terephthalate, polytrimethylene terephthalate, polyethylene naphthalate, and liquid crystal polyester), a polyolefin (e.g., polyethylene, polypropylene, and polybutylene) polyoxymethylene, a polyamide, polyphenylene sulfide, polyketone, polyetherketone, polyether ether ketone, polyetherketoneketone, polyether nitrile, a fluorine-based resin (e.g., polytetrafluoroethylene), a crystalline resin (e.g., liquid crystal polymer), a styrene-based resin, an amorphous resin (e.g., polycarbonate, poly(methyl methacrylate), polyvinyl chloride, polyphenylene ether, polyimide, polyamide-imide, polyetherimide polysulfone, polyether sulphone, and polyarylate), a phenol-based resin, a phenoxy resin, a thermoplastic elastomer (e.g., polystyrene-based thermoplastic elastomer, polyolefin-based thermoplastic elastomer, polyurethane-based thermoplastic elastomer, polyester-based thermoplastic elastomer, polyamide-based thermoplastic elastomer, polybutadiene-based thermoplastic elastomer, polyisoprene-based thermoplastic elastomer, fluorine-based thermoplastic elastomer, and acrylonitrile-based thermoplastic elastomer), and a copolymer and a modified product thereof, a metal material (e.g., cast iron, stainless steel, aluminum, and aluminum alloy), and the like.

When the inner wall-side contact member is disposed in the groove-like coolant passage, the inner wall-side contact member comes in contact with the cylinder bore-side wall surface of the groove-like coolant passage, and is disposed along the longitudinal direction (transverse direction) of the inner wall of the main body over the entirety of the inner wall of the main body, or partially disposed along the longitudinal direction of the inner wall of the main body. The outer wall-side contact member is disposed along the longitudinal direction (transverse direction) of the outer wall of the main body over the entirety of the outer wall of the main body, or partially disposed along the longitudinal direction of the outer wall of the main body. When the water jacket spacer has been disposed in the groove-like coolant passage, the inner wall-side contact member has come in contact with the cylinder bore-side wall surface of the groove-like coolant passage, and the outer wall-side contact member has come in to contact with the outer wall surface of the groove-like coolant passage, the groove-like coolant passage is divided into the upper passage and the lower passage.

In the example illustrated in FIG. 4, both the inner wall-side contact member and the outer wall-side contact member are continuously provided along the longitudinal direction of the main body. Note that the configuration is not limited thereto. For example, the inner wall-side contact member or the outer wall-side contact member may be broken as long as it is possible to substantially separately adjust the flow rate of the coolant that flows through the upper passage of the groove-like coolant passage, and the flow rate of the coolant that flows through the lower passage of the groove-like coolant passage.

In the example illustrated in FIG. 4, the inner wall-side contact member or the outer wall-side contact member is disposed on the inner wall side or the outer wall side of the main body in a state in which the inner wall-side contact member or the outer wall-side contact member is fitted into the receiving section formed on the inner wall side or the outer wall side of the main body. Note that the configuration is not limited thereto. An arbitrary method may be used as long as the inner wall-side contact member or the outer wall-side contact member be provided to the main body.

The thickness (i.e., the length indicated by reference numeral 25 in FIG. 6) of the inner wall-side contact member or the outer wall-side contact member is not particularly limited, but is preferably 0.1 to 5.0 mm, and particularly preferably 0.5 to 3.0 mm. The length (i.e., the length indicated by reference numeral 26 in FIG. 6) from the contact part of the inner wall-side contact member to the contact part of the outer wall-side contact member is appropriately selected corresponding to the groove-like coolant passage.

A material firm producing the inner wall-side contact member or the outer wall-side contact member is not particularly limited as long as the inner wall-side contact member or the outer wall-side contact member can come in contact with the cylinder bore-side wall surface or the outer wall surface of the groove-like coolant passage to substantially divide the groove-like coolant passage into the upper passage and the lower passage, and the material exhibits excellent LLC resistance, and exhibits a heat resistance sufficient to endure the temperature of the cylinder bore-side wall surface within the groove-like coolant passage. It is preferable that the inner wall-side contact member and the outer wall-side contact member be formed of a rubber material having a rubber hardness of 5 to 50, and particularly preferably 10 to 30. Examples of the material for producing the inner wall-side contact member or the outer wall-side contact member include a silicone rubber, a fluororubber, a natural rubber, a butadiene rubber, an ethylene-propylene-diene rubber (EPDM), a nitrile-butadiene rubber (NBR), and the like. It is preferable to use a heat-expandable rubber such as a silicone rubber, a fluororubber, a natural rubber, a butadiene rubber, an ethylene-propylene-diene rubber (EPDM), or a nitrile-butadiene rubber (NBR). The term “heat-expandable rubber” used herein refers to a composite obtained by impregnating a base foam material with a thermoplastic substance having a melting point lower than that of the base foam material, and compressing the resulting product. The heat-expandable rubber is characterized in that the compressed state is maintained at room temperature by the cured product of the thermoplastic substance that is present at least in the surface area, and the cured product of the thermoplastic substance softens due to heating so that the compressed state is canceled. When the inner wall-side contact member or the outer wall-side contact member is formed of the heat-expandable rubber, the heat-expandable rubber expands (is deformed) to have a specific shape when the water jacket spacer according to one embodiment of the invention has been disposed in the groove-like coolant passage, and heat has been applied to the heat-expandable rubber. Examples of the base foam material used to produce the heat-expandable rubber include a silicone rubber, a fluororubber, a natural rubber, a butadiene rubber, an ethylene-propylene-diene rubber (EPDM), and a nitrile-butadiene rubber (NBR). It is preferable to use a thermoplastic substance having a glass transition temperature, a melting point, or a softening temperature of less than 120° C. as the thermoplastic substance used to produce the heat-expandable rubber. Examples of the thermoplastic substance used to produce the heat-expandable rubber include a thermoplastic resin such as polyethylene, polypropylene, polystyrene, polyvinyl chloride, polyvinylidene chloride, polyvinyl acetate, a polyacrylate, a styrene-butadiene copolymer, chlorinated polyethylene, polyvinylidene fluoride, an ethylene-vinyl acetate copolymer, an ethylene-vinyl acetate-vinyl chloride-acrylate copolymer, an ethylene-vinyl acetate-acrylate copolymer, an ethylene-vinyl acetate-vinyl chloride copolymer, nylon, an acrylonitrile-butadiene copolymer, polyacrylonitrile, polyvinyl chloride, polychloroprene, polybutadiene, a thermoplastic polyimide, a polyacetal, polyphenylene sulfide, a polycarbonate, and a thermoplastic polyurethane, and a thermoplastic compound such as a low-melting-point glass frit, starch, a solder, and a wax.

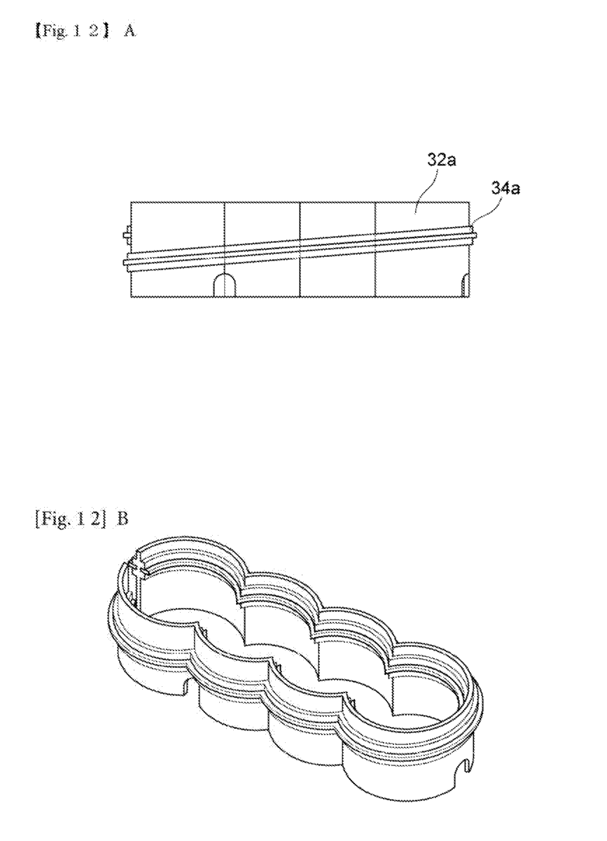

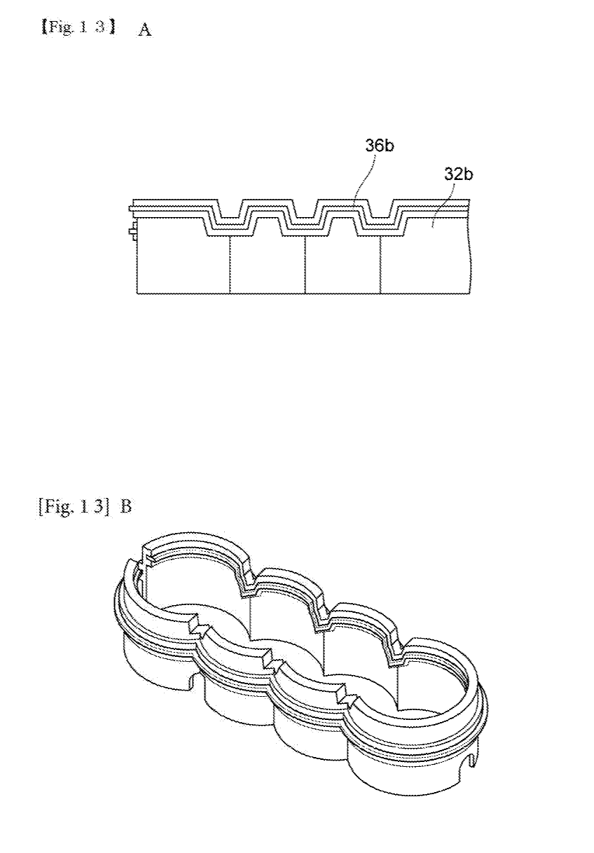

In the example illustrated in FIG. 4, the position of the inner wall-side contact member or the outer wall-side contact member in the height direction of the main body is constant along the longitudinal direction of the main body. Note that the configuration is not limited thereto. For example, an outer wall-side contact member 34a may be provided to the outer wall surface of a main body 32a so that the position of the outer wall-side contact member 34a in the height direction changes along the longitudinal direction of the main body (see FIG. 12). Alternatively, an inner wall-side contact member 36b may be provided to the outer wall surface of a main body 32b so that part of the inner wall-side contact member 36b along the longitudinal direction of to the main body differs from the remaining part as to the position in the height direction (see FIG. 13).

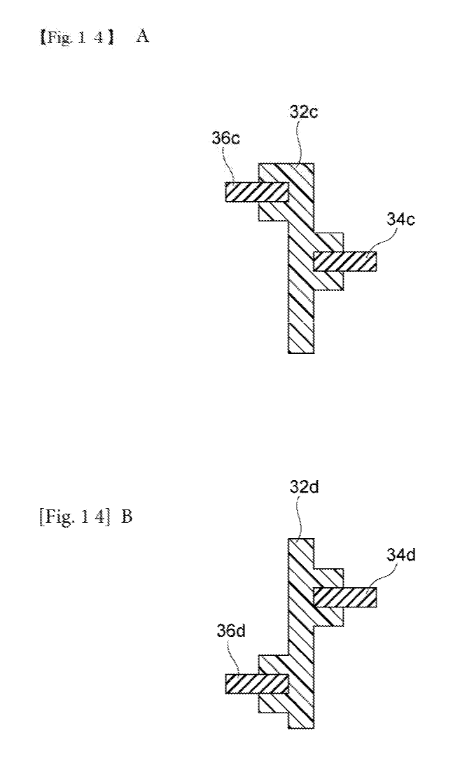

In the example illustrated in FIG. 4, the position of the inner wall-side contact member and the position of the outer wall-side contact member in the height direction are identical to each other along the longitudinal direction of the main body. Note that the configuration is not limited thereto. For example, an inner wall-side contact member 36c and an outer wall-side contact member 34c may be provided to a main body 32c so that the position of the inner wall-side contact member 36c in the height direction is higher than the position of the outer wall-side contact member 34c in the height direction (see (A) in FIG. 14). Alternatively, an inner wall-side contact member 36d and an outer wall-side contact member 34d may be provided to a main body 32d so that the position of the inner wall-side contact member 36d in the height direction is lower than the position of the outer wall-side contact member 34d in the height direction (see (B) in FIG. 14).

When the water jacket spacer according to one aspect of the invention has been disposed in the groove-like coolant passage, the inner wall-side contact member has come in contact with the cylinder bore-side wall surface of the groove-like coolant passage, and the outer wall-side contact member has come in contact with the outer wall surface of the groove-like coolant passage, the groove-like coolant passage that is situated on the inner side with respect to the water jacket spacer, or the groove-like coolant passage that is situated on the outer side with respect to the water jacket spacer, is divided into the upper passage and the lower passage. Therefore, it is possible to separately adjust the flow rate of the coolant that flows through the upper passage of the groove-like coolant passage, and the flow rate of the coolant that flows through the lower passage of the groove-like coolant passage, so that the desired flow rate is achieved. This makes it possible to separately adjust the flow rate of the coolant that flows through the upper passage of the groove-like coolant passage, and the flow rate of the coolant that flows through the lower passage of the groove-like coolant passage, corresponding to the difference in temperature between the upper part and the lower part of the cylinder bore wall, or a change in wall temperature, so that the upper part and the lower part of the cylinder bore wall have a uniform temperature. Therefore, the water jacket spacer according to one aspect of the invention ensures that the cylinder bore wall has a uniform temperature.

An internal combustion engine according to another aspect of the invention includes the water jacket spacer according to one aspect of the invention that is disposed in a groove-like coolant passage provided to a cylinder block. An automobile according to a further aspect of the invention includes the internal combustion engine according to one aspect of the invention.

### INDUSTRIAL APPLICABILITY

According to the embodiments of the invention, since the difference in the amount of deformation between the upper part and the lower part of the cylinder bore wall of an internal combustion engine can be reduced (i.e., friction with respect to a piston can be reduced), it is possible to provide a fuel-efficient internal combustion engine.

### REFERENCE SIGNS LIST

1: Water jacket spacer
2, 32a, 32b, 32c, 32d: Main body
3: Outer wall-side contact member-receiving section
4, 34a, 34c, 34d: Outer wall-side contact member
5: Inner wall-side contact member-receiving section
36b 36c, 36d: Inner wall-side contact member
7: Inflow hole
11: Cylinder block
12: Bore
13: Cylinder bore wall
14: Groove-like coolant passage
15a, 15b: Coolant inlet
16a, 16b: Coolant outlet
17: Cylinder bore-side wall surface of groove-like coolant passage
18: Outer wall surface of groove-like coolant passage
23: Upper passage of groove-like coolant passage
24: Lower passage of groove-like coolant passage

1. A water jacket spacer that is inserted into a groove-like coolant passage provided to a cylinder block that is provided to an internal combustion engine, the water jacket spacer comprising a main body that has a shape that conforms to the groove-like coolant passage, and either or both of an inner wall-side contact member and an outer wall-side contact member, the inner wall-side contact member being disposed on an inner wall side of the main body along a longitudinal direction of an inner wall of the main body, and coming into contact with a cylinder bore-side wall surface of the groove-like coolant passage to divide the groove-like coolant passage situated on an inner side with respect to the water jacket spacer into an upper part and a lower part, and the outer wall-side contact member being disposed on an outer wall side of the main body along a longitudinal direction of an outer wall of the main body, and coming into contact with an outer wall surface of the groove-like coolant passage to divide the groove-like coolant passage situated on an outer side with respect to the water jacket spacer into an upper part and a lower part.

2. A water jacket spacer that is inserted into a groove-like coolant passage provided to a cylinder block that is provided to an internal combustion engine, the water jacket spacer comprising a main body that has a shape that conforms to the entirety of the groove-like coolant passage, an inner wall-side contact member, and an outer wall-side contact member, the inner wall-side contact member being disposed on an inner wall side of the main body along a longitudinal direction of an inner wall of the main body over the entirety of the inner wall of the main body, and coming into contact with a cylinder bore-side wall surface of the groove-like coolant passage to divide the groove-like coolant passage situated on the inner side with respect to the water jacket spacer into an upper part and a lower part, and the outer wall-side contact member being disposed on an outer wall side of the main body along a longitudinal direction of an outer wall of the main body over the entirety of the outer wall of the main body, and coining into contact with an outer wall surface of the groove-like coolant passage to divide the groove-like coolant passage situated on an outer side with respect to the water jacket spacer into an upper part and a lower part.

3. A water jacket spacer that is inserted into a groove-like coolant passage provided to a cylinder block that is provided to an internal combustion engine, the water jacket spacer comprising a main body that has a shape that conforms to the entirety of the groove-like coolant passage, and an inner wall-side contact member, the inner wall-side contact member being disposed on an inner wall side of the main body along a longitudinal direction of an inner wall of the main body over the entirety of the inner wall of the main body, and coming into contact with a cylinder bore-side wall surface of the groove-like coolant passage to divide the groove-like coolant passage situated on an inner side with respect to the water jacket spacer into an upper part and a lower part.

4. A water jacket spacer that is inserted into a groove-like coolant passage provided to a cylinder block that is provided to an internal combustion engine, the water jacket spacer comprising a main body that has a shape that conforms to the entirety of the groove-like coolant passage, and an outer wall-side contact member, the outer wall-side contact member being disposed on an outer wall side of the main body along a longitudinal direction of an outer wall of the main body over the entirety of the outer wall of the main body, and coming into contact with an outer wall surface of the groove-like coolant passage to divide the groove-like coolant passage situated on an outer side with respect to the water jacket spacer into an upper part and a lower part.

5. A water jacket spacer that is inserted into a groove-like coolant passage provided to a cylinder block that is provided to an internal combustion engine, the water jacket spacer comprising a main body that has a shape that conforms to the entirety of the groove-like coolant passage, an inner wall-side contact member, and an outer wall-side contact member, the inner wall-side contact member being partially disposed on an inner wall side of the main body along a longitudinal direction of an inner wall of the main body, and coming into contact with a cylinder bare-side wall surface of the groove-like coolant passage to divide the groove-like coolant passage situated on the inner side with respect to the water jacket spacer into an upper part and a lower part, and the outer wall-side contact member being partially disposed on an outer wall side of the main body along a longitudinal direction of an outer wall of the main body, and coming into contact with an outer wall surface of the groove-like coolant passage to divide the groove-like coolant passage situated on an outer side with respect to the water jacket spacer into an upper part and a lower part.

6. A water jacket spacer that is inserted into a groove-like coolant passage provided to a cylinder block that is provided to an internal combustion engine, the water jacket spacer comprising a main body that has a shape that conforms to part of the groove-like coolant passage, an inner wall-side contact member, and an outer wall-side contact member, the inner wall-side contact member being disposed on an inner wall side of the main body along a longitudinal direction of an inner wall of the main body over, the entirety of the inner wall of the main body, and coming into contact with a cylinder bore-side wall surface of the groove-like coolant passage to divide the move-like coolant passage situated on the inner side with respect to the water jacket spacer into an upper part and a lower part, and the outer wall-side contact member being disposed on an outer wall side of the main body along a longitudinal direction of an outer wall of the main body over the entirety of the outer wall of the main body, and coming into contact with an outer wall surface of the groove-like coolant passage to divide the groove-like coolant passage situated on an outer side with respect to the water jacket spacer into an upper part and a lower part.

7. A water jacket spacer that is inserted into a groove-like coolant passage provided to a cylinder block that is provided to an internal combustion engine, the water jacket spacer comprising a main body that has a shape that conforms to part of the groove-like coolant passage, and an inner wall-side contact member, the inner wall-side contact member being disposed on an inner wall side of the main body along a longitudinal direction of an inner wall of the main body over the entirety of the inner wall of the main body, and coining into contact with a cylinder bore-side wall surface of the groove-like coolant passage to divide the groove-like coolant passage situated on an inner side with respect to the water jacket spacer into an upper part and a lower part.

8. A water jacket spacer that is inserted into a groove-like coolant passage provided to a cylinder block that is provided to an internal combustion engine, the water jacket spacer comprising a main body that has a shape that conforms to part of the groove-like coolant passage, and an outer wall-side contact member, the outer wall-side contact member being disposed on an outer wall side of the main body along a longitudinal direction of an outer wall of the main body over the entirety of the outer wall of the main body, and coining into contact with an outer wall surface of the groove-like coolant passage to divide the groove-like coolant passage situated on an outer side with respect to the water jacket spacer into an upper part and a lower part.

9. A water jacket spacer that is inserted into a groove-like coolant passage provided to a cylinder block that is provided to an internal combustion engine, the water jacket spacer comprising a main body that has a shape that conforms to part of the groove-like coolant passage, an inner wall-side contact member, and an outer wall-side contact member, the inner wall-side contact member being partially disposed on an inner wall side of the main body along a longitudinal direction of an inner wall of the main body, and coming into contact with a cylinder bore-side wall surface of the groove-like coolant passage to divide the groove-like coolant passage situated on the inner side with respect to the water jacket spacer into an upper part and a lower part, and the outer wall-side contact member being partially disposed on an outer wall side of the main body along a longitudinal direction of an outer wall of the main body, and coming into contact with an outer wall surface of the groove-like coolant passage to divide the groove-like coolant passage situated on an outer side with respect to the water jacket spacer into an upper part and a lower part.

10. The water jacket spacer according to claim 1, wherein the inner wall-side contact member or the outer wall-side contact member has a thickness of 0.1 to 5.0 mm.

11. The water jacket spacer according to claim 1, wherein the inner wall-side contact member or the outer wall-side contact member is formed of a rubber material having a rubber hardness of 5 to 50.

12. The water jacket spacer according to claim 1, wherein the inner wall-side contact member or the outer wall-side contact member is formed of a silicone rubber, a fluororubber, an ethylene-propylene-diene rubber (EPDM), or a nitrile-butadiene rubber (NBR).

13. The water jacket spacer according to claim 12, wherein the inner wall-side contact member or the outer wall-side contact member is formed of a heat-expandable rubber that comprises a silicone rubber, a fluororubber, an ethylene-propylene-diene rubber (EPDM), or a nitrile-butadiene rubber (NBR).

14. An internal combustion engine comprising the water jacket spacer according to claim 1, the water jacket spacer being disposed in a groove-like coolant passage provided to a cylinder block.

15. An automobile comprising the internal combustion engine according to claim 14.

16. An internal combustion engine comprising the water jacket spacer according to claim 2, the water jacket spacer being disposed in a groove-like coolant passage provided to a cylinder block.

17. An internal combustion engine comprising the water jacket spacer according to claim 3, the water jacket spacer being disposed in a groove-like coolant passage provided to a cylinder block.

18. An internal combustion engine comprising the water jacket spacer according to claim 4, the water jacket spacer being disposed in a groove-like coolant passage provided to a cylinder block.

19. An internal combustion engine comprising the water jacket spacer according to claim 5. the water jacket spacer being disposed in a groove-like coolant passage provided to a cylinder block.

20. An internal combustion engine comprising the water jacket spacer according to claim 6, the water jacket spacer being disposed in a groove-like coolant passage provided to a cylinder block.
